(19) United States
(12) Patent Application Publication
(10) Pub. No.: US 2010/0107096 A1
(43) Pub. Date: Apr. 29, 2010

(54) Generic Visually Enhanced Platform For Aiding Decision Making Processes

(76) Inventors: Guy Mor, Rechovot (IL); Shlomo Gadot, Hertzelia (IL)

Correspondence Address: The Law Office of Michael E. Kondoudis, 888 16th Street, N.W., Suite 800, Washington, DC, 20006, US

(21) Appl. No.: 12/258,392

(22) Filed: Oct. 25, 2008

(51) Int. Cl. G06F 3/048; G06N 5/04

(52) U.S. Cl. 715/764; 706/47

(57) ABSTRACT

A computer system including a server computer with a graphical user interface associated with users and a dynamic content database, and a method of assisting users with a multiple stage decision making process. The graphical user interface visualizes objects, mathematical operation and logical operations required for executing a generic decision making process. The method: enables the users to visually express, in a stage by stage form, a particular decision making process; iteratively and responsively provides the users with instructive queries that are arranged to instruct the users how to further define the next stage of the particular process, until the particular decision making process is defined; applies the defined decision making process on the dynamic content database; provides the users with the results of the decision making process; and debugs the decision making process as constructed by the user.

### FIELD OF THE INVENTION

The present invention generally but not exclusively relates to the field of decision making. More particularly, the present invention relates to a computerized system and method to help user in decision making by continuously visualizing the process.

### BACKGROUND OF THE INVENTION

The following patents and patent applications are each incorporated herein by reference in its entirety: U.S. Patent Publication No. US2007003914 discloses a consulting system helping a user on collecting information, building object model, and creating virtual environment, producing animated images, capturing feedback from the user, analyzing user's response, and providing advices in various formats; U.S. Patent Publication No. US2003046201 discloses a system and method for implementing an open services market platform including a layered architecture that accelerates the development and customization of applications in a given marketplace and accommodates integration between multiple marketplaces and/or business partners in a public or private electronic marketplace; U.S. Patent Publication No. US2002116243 discloses an expert system adapted allowing an agent to interact with a customer and to provide selection and recommendation of data network products and/or services for the customer; U.S. Pat. No. 6,741,975 discloses an expert system regularly updated by advice (or diagnosis, recommendation etc.) given by practitioners in the relevant field. The combination of the underlying facts and the consequent (human) advice is used to update a rule set that is then used to provide automated advice; and U.S. Patent Publication No. US2006122850 discloses a method and system enabling users to access a plurality of professional service providers and knowledge experts.

### BRIEF SUMMARY

The present invention includes a computer system exhibiting a server computer with a graphical user interface operatively associated with at least one user and a dynamic content database, and a method of assisting at least one user with a multiple stage decision making process.

According to an aspect of the present invention, there is method that comprises: providing a graphical user interface arranged to visualize the objects, mathematical operation and logical operations required for executing a generic decision making process; enabling the users to visually express in a stage by stage form, a particular decision making process (such as procedures, flow charts or processes) using the graphical user interface; iteratively providing the users with instructive queries responsive to the users' expression of each of the stages of the decision making process; applying the defined decision making process on the dynamic content database; and providing the users with the results of the decision making process. The instructive queries are arranged to instruct the users how to further define the next stage of the particular process, until the particular decision making process is defined.

In embodiments, the method further comprises debugging the decision making process as constructed by the user.

According to another aspect of the present invention, there is provided a system for assisting users with a multiple stage decision making process relating to a dynamic content database. The system includes a server computer comprising a graphical user interface connected via at least one communication link to the users and to the dynamic content database. The graphical user interface is arranged to visualize objects, mathematical operations and logical operations required for executing a generic decision making process by the users. The graphical user interface is further arranged to enable the users to visually express, in a stage by stage form, a particular decision making process. The server computer is arranged to iteratively provide the users with at least one instructive query responsive to the users' expression of each of the stages of the decision making process, such that the at least one instructive query is arranged to instruct the users how to further define the next stage of the particular process, until the particular decision making process is defined. The server computer is arranged to apply the defined decision making process on the dynamic content database and provide the users with the results of the decision making process.

### BRIEF DESCRIPTION OF THE DRAWINGS

The subject matter regarded as the invention will become more clearly understood in light of the ensuing description of embodiments herein, given by way of example and for purposes of illustrative discussion of the present invention only, with reference to the accompanying drawings (Figures, or simply “FIGS.”), wherein:

FIG. 1 illustrates a method of assisting at least one user with a multiple stage decision making process, according to some embodiments of the invention; and

FIG. 2 is a block diagram illustrating a system for assisting users with a multiple stage decision making process, according to some embodiments of the invention.

### DETAILED DESCRIPTIONS OF SOME EMBODIMENTS OF THE INVENTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting. In other instances, well-known methods, procedures, components and circuits have not been described in detail so as not to obscure the teachings of the present disclosure.

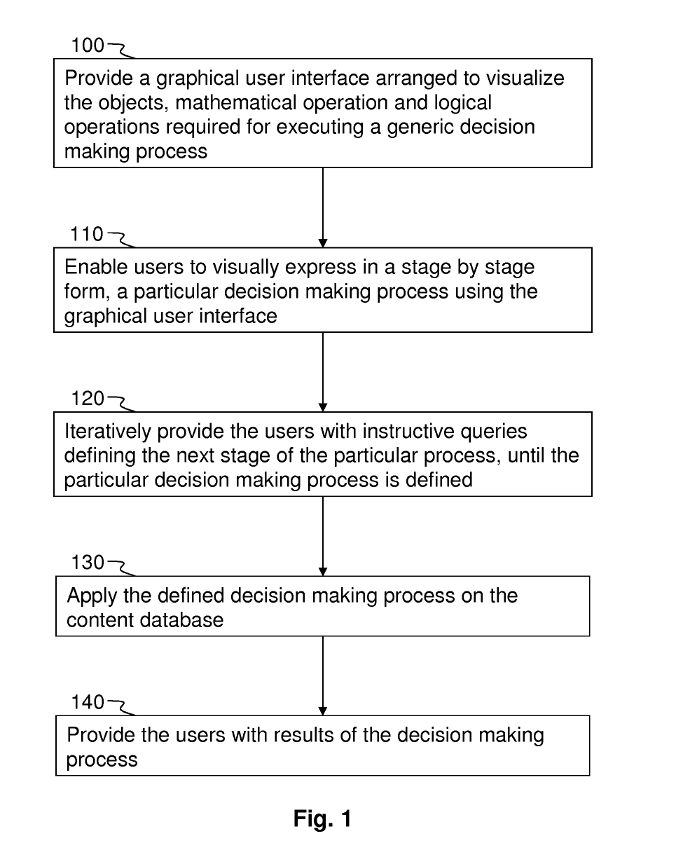

FIG. 1 illustrates a method of assisting at least one user with a multiple stage decision making process, according to some embodiments of the invention. The method may be implemented in a computer system exhibiting a server computer operatively associated with a plurality of users and a dynamic content database. The method comprises the stages:
providing a graphical user interface (stage 100) arranged to visualize objects, mathematical operation and logical operations required for executing a generic decision making process;
enabling at least one user to visually express, in a stage by stage form, a particular decision making process using the graphical user interface (stage 110);
iteratively providing the at least one user with instructive queries (stage 120) responsive to the user's expression of each of the stages of the decision making process, wherein the queries are arranged to instruct the user how to further define the next stage of the particular process, by values, preferences, attributes etc. until the particular decision making process is defined;
applying the defined decision making process to the content database (stage 130); and
providing the at least one user with the results of the decision making process (stage 140).

According to some embodiments of the invention, the method may further comprise characterizing attributes of the decision making process and debugging the decision making process as constructed by the user.

According to some embodiments of the invention, enabling visually expressing a stage of a particular decision making process (stage 110) is executed by enabling the at least one user to drag and drop objects, mathematical operation and logical operations required for executing a particular decision making process.

According to some embodiments of the invention, iteratively providing the users with instructive queries (stage 120) responsive to the user's expression of each of the stages of the decision making process is executed partly by experts authorized to access the content database. The experts may be presented with the visually expressed stages of a particular decision making process and may be further enabled to alter the visual expression of the stages. According to some embodiments of the invention, the experts may be enabled to provide the users with instructive queries responsive to the user's expression of each of the stages of the decision making process in real time.

According to some embodiments of the invention, the users may be enabled to store at least one visually expressed stage of the decision making process on the content database. The users may further be enabled to share at least one visually expressed stage of the decision making process with other users, or be enabled to search at least one visually expressed stage of a particular decision making process stored on the content database. According to some embodiments of the invention, the users may be identified by permissions.

According to some embodiments of the invention, objects of a particular decision making process may be services, products, or combinations thereof. The decision making process itself may relate to any area of life and be of arbitrary extension.

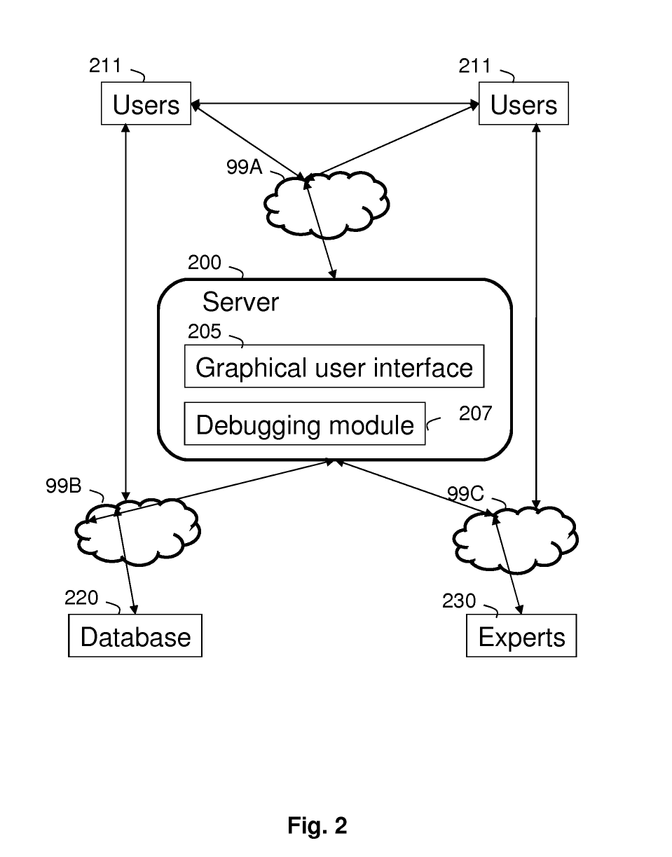

FIG. 2 is a block diagram illustrating a system for assisting users 211 with a multiple stage decision making process, according to some embodiments of the invention. The system comprises a server computer 200 with a graphical user interface 205 connected via communication links 99A, 99B to users 211, a dynamic content database 220 (respectively), such that the server computer 200 is operatively associated with users 211 and dynamic content database 220. Graphical user interface 205 is arranged to visualize objects, mathematical operations and logical operations required for executing a generic decision making process by users 211. Graphical user interface 205 is further arranged to enable users 211 to visually express (or perform) in a stage by stage form, a particular decision making process. Server computer 200 is arranged to iteratively provide users 211 with instructive queries responsive to the users' expression of each of the stages of the decision making process. The queries are arranged to instruct users 211 how to further define the next stage of the particular process, until the particular decision making process is defined. Finally, server computer 200 is arranged to apply the defined decision making process on dynamic content database 220 and provide users 211 with the results of the decision making process.

According to some embodiments of the invention, server 200 is also connected via communication link 99C to experts 230 authorized to access dynamic content database 220. Server 200 may be arranged to enable experts 230 to provide users 211 with at least a part of the instructive queries.

The system is characterized by its openness, flexibility and ease to use. The graphical objects and the mathematical functions are predefined and alleviate the expression as well as processes and procedures of the decision making processes. According to some embodiments of the invention, the system allows users 211 to add and remove objects and function by drag and drop. Users 211 may use the system remotely. The system allows users 211 to choose products and services explicitly according to self defined parameters and weights. The system further enables modification and inclusion of external experts.

According to some embodiments of the invention, users 211 may be allocated permissions to access the system, that define their decision processes and allowances. Objects in the decision making process may be envisioned as a logical tree of an unlimited size, with removable, extendable and interchangeable objects and branches which may be updated at any time (e.g. Linux like). Users 211 may define and control their preferences and the weights (values) of any parameters of the decision making process.

According to some embodiments of the invention, the system may further comprise a debugging module 207 arranged to assist users 211 in their expression of their particular decision making process, and supply related (relevant) information.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention can be implemented in the testing or practice with methods and materials equivalent or similar to those described herein.

While the invention has been described with respect to a limited number of embodiments, these should not be construed as limitations on the scope of the invention, but rather as exemplifications of some of the preferred embodiments. Those skilled in the art will envision other possible variations, modifications, and applications that are also within the scope of the invention. Accordingly, the scope of the invention should not be limited by what has thus far been described, but by the appended claims and their legal equivalents.

What is claimed is:

1. In a computer system exhibiting a server computer operatively associated with a plurality of users and a dynamic content database, a method of assisting at least one user with a multiple stage decision making process, the method comprising:
providing a graphical user interface arranged to visualize objects, mathematical operations and logical operations required for executing a generic decision making process;
enabling at least one user to visually express, in a stage by stage form, a particular decision making process using the graphical user interface;
iteratively providing the at least one user with instructive queries responsive to the user's expression of each of the stages of the decision making process, wherein the queries are arranged to instruct the user how to further define the next stage of the particular process, until the particular decision making process is defined; and
applying the defined decision making process to the dynamic content database.

2. The method according to claim 1, wherein of the enabling at least one user to visually express a particular decision making process is executed by enabling the at least one user to drag and drop objects, mathematical operation and logical operations required for executing a particular decision making process.

3. The method according to claim 1, wherein the iteratively providing the at least one user with instructive queries responsive to the user's expression of each of the stages of the decision making process is executed partly by experts authorized to access the dynamic content database.

4. The method according to claim 3, wherein the experts are presented with the visually expressed stages of a particular decision making process and are further enabled to alter the visual expression thereof.

5. The method according to claim 3, wherein the experts are enabled to provide the at least one user with instructive queries responsive to the user's expression of each of the stages of the decision making process in real time.

6. The method according to claim 1, wherein the at least one user is enabled to store at least one visually expressed stage of the decision making process on the dynamic content database.

7. The method according to claim 6, wherein the at least one user is enabled to share at least one visually expressed stage of the decision making process with other user users.

8. The method according to claim 6, wherein the at least one user is enabled to search at least one visually expressed stage of a particular decision making process stored on the dynamic content database.

9. The method according to claim 1, wherein the objects of a particular decision making process are services.

10. The method according to claim 1, wherein the at least one user is identified by at least one permission.

11. The method according to claim 1, wherein the objects of a particular decision making process are products.

12. The method according to claim 1, further comprising debugging the decision making process as constructed by the user.

13. A system for assisting users with a multiple stage decision making process relating to a dynamic content database, the system comprising:
a server computer comprising a graphical user interface connected via at least one communication link to the users and to the dynamic content database,
wherein the graphical user interface is arranged to visualize objects, mathematical operations and logical operations required for executing a generic decision making process by the users;
wherein the graphical user interface is further arranged to enable the users to visually express in a stage by stage form, a particular decision making process;
wherein the server computer is arranged to iteratively provide the users with at least one instructive query responsive to the users' expression of each of the stages of the decision making process, such that the at least one instructive query is arranged to instruct the users how to further define the next stage of the particular process, until the particular decision making process is defined; and
wherein the server computer is arranged to apply the defined decision making process on the dynamic content database and provide the users with the results of the decision making process.

14. The system of claim 13, wherein the server is further connected via at least one communication link to at least one expert authorized to access the dynamic content database, and wherein the server is arranged to enable the at least one expert to provide the users with at least a part of the instructive queries.

15. The system of claim 13, wherein the server computer further comprises a debugging module arranged to assist the users in their expression of their particular decision making process, and supply related information.
